(19) United States
(12) Patent Application Publication
(10) Pub. No.: US 2012/0194476 A1
(43) Pub. Date: Aug. 2, 2012

(54) TOUCH PANEL CAPABLE OF MULTI-TOUCH SENSING, AND MULTI-TOUCH SENSING METHOD FOR THE TOUCH PANEL

(75) Inventors: Bang-Won Lee, Yongin-si (KR); Se-Eun Jang, Yongin-si (KR); Jae-Surk Hong, Yongin-si (KR); Xiaoling Wu, Yongin-si (KR)

(73) Assignee: ATLAB INC., Yongin-si (KR)

(21) Appl. No.: 13/500,002

(22) PCT Filed: Jul. 9, 2010
(86) PCT No.: PCT/KR10/04463

§ 371 Date: Apr. 3, 2012

(30) Foreign Application Priority Data
Oct. 19, 2009 (KR) 10-2009-0099458

(51) Int. Cl. G06F 3/044; G06F 3/041; G06F 3/045

(52) U.S. Cl. 345/174; 345/173

(57) ABSTRACT

Provided are a touch panel capable of detecting a multi-touch and a multi-touch detecting method thereof. Since the touch panel and the multi-touch detecting method thereof can measure and store each resistance of a plurality of first and second touch pads varied depending on the touch position of a contact object and capacitance of the contact object using a variation in detection time to determine an actual touch position of the contact object, it is possible to determine the actual touch position even when a ghost pattern occurs.

### TECHNICAL FIELD

The present invention relates to a touch panel and a method of sensing a multi-touch thereof, and more particularly, to a touch panel capable of a multi-touch and a method of sensing a multi-touch thereof.

### BACKGROUND ART

Most electronic systems are provided with various input devices at the interior or exterior thereof, receive instructions from the input device, and perform various functions corresponding to the instructions. The input devices may have various forms according to an input method thereof, such as a keyboard, a keypad, a mouse, etc. In addition, in recent times, touch panels are widely used as the input devices to detect a touch position of a contact object, and receive instructions.

In general, the touch panels are installed on surfaces of display devices such as a cathode ray tube (CRT), a liquid crystal display (LCD), a plasma display panel (PDP), an electroluminescent (EL) display device, etc., to detect touch positions of a contact object. The input devices having such touch panels may receive instructions through an operation in which a user touches a specific position on the touch panel with a contact object (for example, a finger, a stylus, etc).

Generally, the touch panel includes a plurality of touch pads configured to detect touches. The touch pads may be implemented in various forms depending on touch detection methods. For example, when the touch panel includes a plurality of first touch pads extending in a first direction and a plurality of second touch pads extending in a second direction perpendicular to the first direction and is touched, it is possible to detect a contact signal through the first and second touch pads to determine the touch position.

While most conventional touch panels can detect only one touch, the electronic systems having the touch panels require various functions, and therefore, a need for touch panels configured to detect a multi-touch has increased. In particular, in order to perform a zoom-in or zoom-out operation according to a distance between the touch positions and rotate displayed information according to a rotation angle of the touch positions, it is possible to use the touch panels capable of recognizing a multi-touch.

However, when a multi-touch occurs at the touch panel including the first and second touch pads, it is impossible to discriminate a contact signal of an actual touch position and a contact signal of a position symmetrical to the actual touch position. For example, when the first and second touch pads designate x-axis and y-axis coordinates, respectively, provided that two contact objects touch coordinates (3, 2) and (6, 5), it is impossible for the touch panel to determine which is an actual touch position among the two actual touch positions of coordinates (3, 2) and (6, 5) and two imaginary touch positions of coordinates (3, 5) and (6, 2) symmetrical to the actual touch positions. Hereinafter, the imaginary touch positions generated due to the multi-touch will be referred to as ghost patterns.

Conventional touch panels for detecting a multi-touch include a plurality of touch pads disposed in a matrix in order to detect the multi-touch, not generating a ghost pattern. The plurality of touch pads may have different shapes to generate different contact signals. Alternatively, a touch sensor for detecting a signal applied from the touch pad to determine a touch may be individually connected to each touch pad to determine the multi-touch. That is, the plurality of touch pads disposed in a matrix may be configured to individually detect a touch. As examples of the plurality of touch pads disposed in a matrix to detect each touch, LCD panels including a surface computer and a photo-sensor are disclosed in Japanese Patent Application Publication No. 2001-323605 and U.S. Pat. No. 6,995,743. However, since the conventional touch panel must have the plurality of touch pads having different shapes or individually connected to the touch sensor, its design may be complicated and its manufacturing cost may be increased.

### DISCLOSURE

### Technical Problem

In order to solve the foregoing and/or other problems, it is an aspect of the present invention to provide a touch panel that can be readily manufactured and can accurately determine an actual touch position upon a multi-touch.

It is another aspect of the present invention to provide a touch position detecting method of a touch panel capable of accomplishing the above aspect.

### Technical Solution

The foregoing and/or other aspects of the present invention may be achieved by providing a touch panel including a panel part including a plurality of first touch pads extending in a first direction and a plurality of second touch pads extending in a second direction substantially perpendicular to the first direction; and a touch sensor part connected to one ends of the plurality of first and second touch pads and configured to measure and store resistance values of the plurality of first and second touch pads varied depending on a touch position of a contact position, capacitance values of the contact object and detection time caused by the resistance value and capacitance values and to determine the touch position of the contact object, wherein, when a plurality of touch positions are determined from the detection times corresponding to the plurality of first touch pads and the detection times corresponding to the plurality of second touch pads among the plurality of stored detection times, the touch sensor part compares relative magnitudes of the detection times showing the touch to determine an actual touch position.

In addition, each of the plurality of first touch pads may receive a pulse signal, and delay the pulse signal by the resistance value varied depending on the touch position of the contact object and the capacitance of the contact object at different times to generate a first contact signal, and each of the plurality of second touch pads may receive the pulse signal, and delay the pulse signal by the resistance value varied depending on the touch position of the contact object and the capacitance of the contact object at different times to generate a second contact signal.

Further, the touch sensor part may include a controller configured to output a pulse enable signal to output touch position data to the exterior in response to touch position information; a pulse signal generator configured to generate a pulse signal in response to the pulse enable signal to apply the pulse signal to the plurality of first and second touch pads, and generate a set signal corresponding to the pulse signal to output the set signal; a contact signal detector configured to receive the set signal and the plurality of first and second contact signals to measure a delay time of each of the plurality of first and second contact signals with respect to the set signal to output the plurality of delay times as delayed values; and a touch position determination and storage part configured to receive and store the plurality of delayed values, and determine the actual touch position of the contact object using the plurality of delayed values to output the touch position information.

Furthermore, the touch signal detector may include a buffer part having at least one buffer configured to receive the first and second contact signals; and at least one counter configured to measure the set signal and the detection time of the first and second contact signals applied to the buffer part to output delayed values corresponding to the plurality of first and second touch pads.

In addition, when each of the delayed values corresponding to the plurality of first touch pads and the delayed values corresponding to the plurality of second touch pads among the plurality of stored delayed values represents a plurality of touches, the touch position determination and storage part may compare the delayed values showing the touch to determine the actual touch position and output the touch position information.

Further, each of the plurality of first touch pads may receive a static current, and generate a first contact signal to vary a voltage level by the resistance varied depending on the touch position of the contact object and capacitance of the contact object, and each of the plurality of second touch pads may receive a static current, and generate a second contact signal to vary a voltage level by the resistance varied depending on the touch position of the contact object and capacitance of the contact object.

Furthermore, the touch sensor part may include a controller configured to output a start signal to output touch position data to the exterior in response to touch position information; a current source configured to generate a static current in response to the start signal and apply the static current to the plurality of first and second touch pads; a touch signal detector configured to measure a detection time of each of the plurality of first and second contact signals with respect to the start signal to output a plurality of delayed values; and a touch position determination and storage part configured to receive and store the plurality of delayed values, and determine the actual touch position of the contact object using the plurality of delayed values to output the touch position information.

In addition, the touch signal detector may include at least one comparator configured to receive the first and second contact signals to compare a reference voltage with a voltage level of the first and second contact signals to output an output signal; and at least one counter configured to measure a time difference between the start signal and the output signal to output delayed values corresponding to the plurality of first and second touch pads.

Another aspect of the present invention may be achieved by providing a multi-touch detecting method for a touch panel including a plurality of first touch pads extending in a first direction and a plurality of second touch pads extending in a second direction, which comprises: a pulse signal outputting step of generating a pulse signal in response to a pulse enable signal to output the pulse signal to each of the plurality of first touch pads and the plurality of second touch pads; a delayed value storage step of measuring a delay time of each of the plurality of first and second contact signals output from the plurality of first and second touch pads with respect to the pulse signal to store a plurality of delayed values; a touch determination step of determining existence of the touch of the contact object using the plurality of stored delayed values and whether a multi-touch occurs or not; a ghost pattern determination step of determining whether a ghost pattern occurs when the multi-touch is generated; and a touch position outputting step of comparing relative magnitudes of the delayed values showing a touch among the plurality of stored delayed values depending on a touch position to output an actual touch position when recognition of the ghost pattern is needed.

In addition, the touch determination step may include a delayed value determination step of comparing each of the plurality of stored delayed values with a reference delayed value to determine whether at least one delayed value represents a touch; a single touch determination step of determining whether one delayed value from delayed values corresponding to each of the plurality of first and second touches among the a plurality of stored delayed values represents a touch; and a multi-touch determination step of determining whether a plurality of delayed values among the delayed values corresponding to the plurality of first touch pads or the delayed values corresponding to the plurality of second touch pads represent a touch.

Further, the ghost pattern determination step may include determining that the ghost pattern occurs when the plurality of delayed values represent a touch at each delayed value corresponding to each of the plurality of first and second touch pads.

Furthermore, the touch position outputting step may include comparing the plurality of delayed values showing the touch to determine the actual touch position of a contact object.

### Advantageous Effects

Therefore, a touch panel and a multi-touch detecting method thereof in accordance with the present invention are capable of applying a pulse signal to a plurality of first touch pads and a plurality of second touch pads, and measuring a delay time of a plurality of first and second contact signals output from the plurality of first and second touch pads with respect to the pulse signal to determine the actual touch position, even when a ghost pattern occurs.

### DESCRIPTION OF DRAWINGS

The above and other aspects and advantages of the present invention will become apparent and more readily appreciated from the following description of exemplary embodiments, taken in conjunction with the accompanying drawings of which:

FIG. 1 is a view showing a touch panel in accordance with an exemplary embodiment of the present invention;

FIGS. 2 and 3 represent an actual touch position and an imaginary touch position when a plurality of touch positions are detected;

FIG. 4 is a view of an embodiment of a touch sensor part of FIG. 1;

FIG. 5 is a view showing an equivalent circuit of the touch sensor part and touch pad of FIG. 1;

FIG. 6 is a view showing another example of an equivalent circuit of the touch sensor part and touch pad of FIG. 1;

FIG. 7 is a view showing variation in detection voltage and delay time depending on a touch position;

FIG. 8 is a view showing another embodiment of a touch panel in accordance with the present invention; and

FIG. 9 is a flowchart for explaining a method of detecting a multi-touch in accordance with the present invention.

### MODE FOR INVENTION

Reference will now be made in detail to the embodiments of the present invention, examples of which are illustrated in the accompanying drawings.

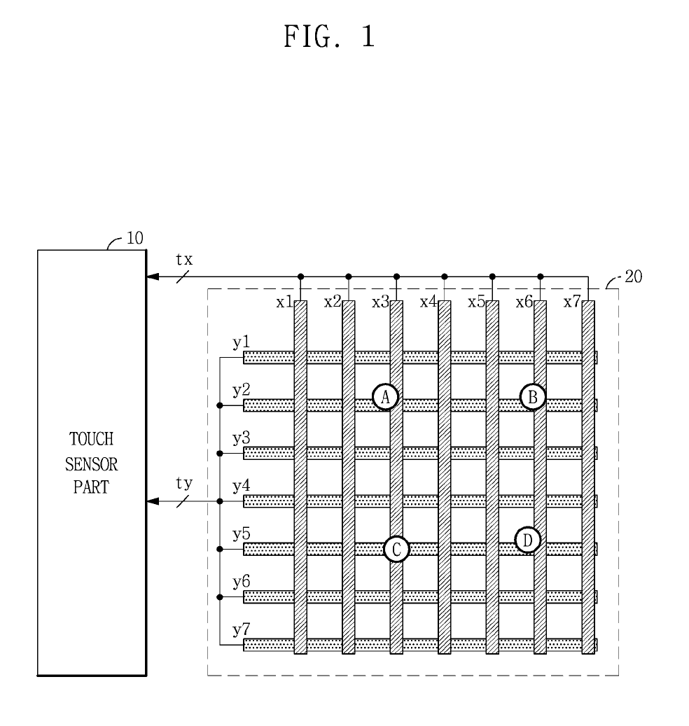

FIG. 1 is a view showing a touch panel in accordance with an exemplary embodiment of the present invention.

The touch panel of FIG. 1 may include a touch sensor part 10 and a panel part 20.

The touch sensor 10 is connected to one ends of a plurality of first and second touch pads x1 to x7 and y1 to y7 to apply a pulse signal through a resistor, and receive a plurality of first contact signals tx1 to tx7 and a plurality of second contact signals ty1 to ty7 in which the pulse signal is delayed, distorted and applied by the plurality of first and second touch pads x1 to x7 and y1 to y7 to calculate coordinates of a touch position in contact with a contact object. In addition, in the case of a multi-touch in which there are a plurality of touch positions, a ghost pattern and an actual touch position are discriminated from each other.

The touch sensor part 10 may sequentially apply a pulse signal through a resistor to the plurality of first and second touch pads x1 to x7 and y1 to y7. When the touch sensor part 10 sequentially applies a predetermined number of pulse signals (e.g., one pulse signal) to the first and second touch pads x1 to x7 and y1 to y7, the plurality of contact signals tx1 to tx7 and ty1 to ty7 are sequentially output from the plurality of first and second touch pads x1 to x7 to y1 to y7. Therefore, the touch sensor part 10 may determine whether each of the touch pads x1 to x7 and y1 to y7 is touched, even when the touch sensor part 10 includes only one sensor (not shown) to detect touches of the plurality of first and second touch pads x1 to x7 and y1 to y7.

However, when the touch sensor part 10 simultaneously applies a pulse signal through a resistor to the plurality of first touch pads x1 to x7 and the plurality of second touch pads y1 to y7, the touch sensor part 10 must almost simultaneously receive the first and second contact signals tx1 to tx7 and ty1 to ty7 applied from the plurality of first and second touch pads x1 to x7 and y1 to y7. Therefore, the touch sensor part 10 may include the number of sensors corresponding to the plurality of first touch pads x1 to x7 or second touch pads y1 to y7. Here, when the pulse signal is simultaneously applied to the plurality of first touch pads x1 to x7 and second touch pads y1 to y7, the pulse signal applied to the first touch pads x1 to x7 may interact with the pulse signal applied to the second touch pads y1 to y7 to cause unexpected distortion. As such, the pulse signal may be applied to the second touch pad y1 to y7 after being applied to the plurality of first touch pads x1 to x7. Therefore, the touch sensor part 10 may include the number of sensors corresponding to the number of touch pads having a larger one of the number of first touch pads x1 to x7 and the number of second touch pads y1 to y7. For example, when the number of first touch pads is eight and the number of second touch pads is six and the pulse signal is simultaneously applied to the first touch pads or the second touch pads, the touch sensor part 10 may include at least eight sensors.

In the panel part 20, the plurality of first touch pads x1 to x7 may be disposed in a first direction, and the plurality of second touch pads y1 to y7 may be disposed in a second direction perpendicular to the first direction.

The plurality of first touch pads x1 to x7 are insulated from the plurality of second touch pads y1 to y7 at their intersections. For example, the panel part 20 includes an indium tin oxide (ITO) film. The plurality of first touch pads x1 to x7 may be formed on a front surface of the ITO film, and the plurality of second touch pads y1 to y7 may be formed on a rear surface of the ITO film. Alternatively, the plurality of first touch pads x1 to x7 and the plurality of second touch pads y1 to y7 may be disposed on the same surface of the ITO film, and an insulating layer may be inserted into the intersections of the first touch pads x1 to x7 and the second touch pads y1 to y7 to electrically insulate them. Further, the first touch pads x1 to x7 and the second touch pads y1 to y7 may be formed on different ITO films. As described above, the touch pad may be formed through various methods. Here, ITO film means film disposed by an ITO material.

Here, the ITO is widely used as transparent electrodes (films) of display devices including liquid crystal displays (LCDs). Since the ITO is transparent conductive oxide material that can provide high transparency, low surface resistance, and easy formation of the pattern, the ITO is widely used for electrode materials in various applications such as organic light emitting diode display devices, solar batteries, plasma display panels, E-papers, etc., in addition to the LCDs, and are applied to Braun tube electromagnetic shielding and ITO ink. However, in recent times, carbon nano-tubes may substitute for the ITO.

The plurality of first touch pads x1 to x7 generate the respective first contact signals tx1 to tx7 depending on the pulse signal applied from the touch sensor part 10 and the touch position in a first direction (for example, an x-axis direction). That is, each of the plurality of first touch pads x1 to x7 receives the pulse signal applied from the touch sensor part 10, delays the applied pulse signal depending on the shape of the first touch pads x1 to x7 and the touch of the contact object, and outputs the delayed pulse signal as the corresponding one of the first contact signals tx1 to tx7. In other words, when the touch sensor part 10 applies the same pulse signal to the plurality of first touch pads x1 to x7, some of the plurality of first touch pads x1 to x7, which are not touched with the contact object, will equally delay the pulse signal to output the first contact signals. However, unlike the first touch pads that are not touched with the contact object, the first touch pads, which are touched with the contact object, may delay the pulse signal by resistance and capacitance of the contact object, to output the first contact signals. Therefore, the touch sensor part 10 may receive the plurality of first contact signals tx1 to tx7 generated through the plurality of first touch pads x1 to x7, and measure a detection time of the plurality of first contact signals tx1 to tx7 to detect the touch position in a first direction.

Each of the plurality of second touch pads y1 to y7 generates the respective second contact signals ty1 to ty7 depending on the pulse signal applied from the touch sensor part 10 and the touch position in a second direction (for example, a y-axis direction). That is, each of the plurality of second touch pads y1 to y7, similar to the first touch pads x1 to x7, receives the pulse signal applied from the touch sensor part 10, delays the pulse signal depending on the touch of the contact object, and outputs the delayed pulse signal as the corresponding of the second contact signal ty1 to ty7. Therefore, the touch sensor part 10 may receive the plurality of second contact signals ty1 to ty7 generated through the second touch pads y1 to y7, and measure a detection time of the plurality of second contact signals ty1 to ty7 to detect the touch position in a second direction.

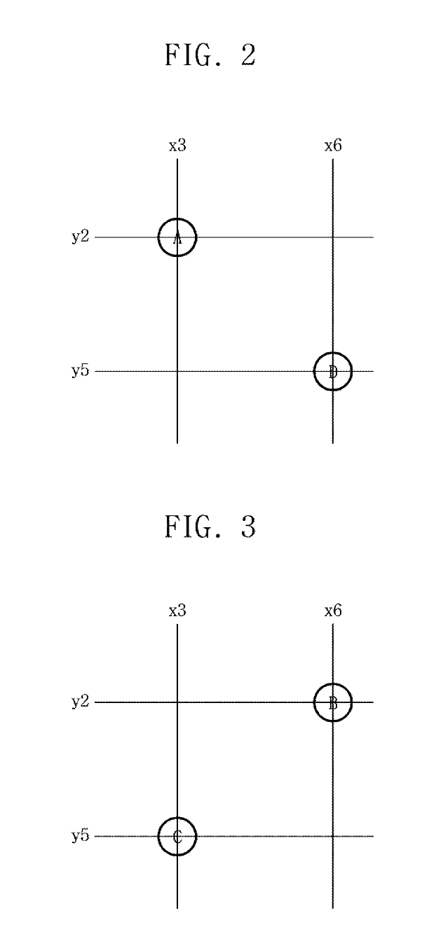

FIGS. 2 and 3 show an actual touch position and an imaginary touch position (i.e. a ghost pattern) when a plurality of touch positions are detected.

When a contact object touches a position A, only the first contact signal tx3 generated through the first touch pad x3 among the plurality of first touch pads x1 to x7 exhibits a touched state, and only the second contact signal ty2 generated through the second touch pad y2 among the second touch pads y1 to y7 exhibits a touched state. That is, the first contact signal tx3 generated through the first touch pad x3 has a waveform different from the other first contact signals tx1, tx2, and tx4 to tx7 generated through the other first touch pads x1, x2, and x4 to x7, not touched with the contact object, to show that the first touch pad x3 is touched with the contact object. In addition, the second contact signal ty2 generated through the second touch pad y2 has a waveform different from the other second contact signals ty1, and ty3 to ty7 generated through the other second touch pad y1, and y3 to y7, not touched with the contact object, to show that the second touch pad y1 is touched with the contact object.

Similarly, when a contact object touches a position B, the first contact signal tx6 shows that the first touch pad x6 is touched by the contact object, and the second contact signal ty2 shows that the second touch pad y2 is touched by the contact object. In addition, when a contact object touches a position C, the first contact signal tx3 shows that the first touch pad x3 is touched by the contact object, and the second contact signal ty5 shows that the second touch pad y5 is touched by the contact object. Further, when a contact object touches a position D, the first contact signal tx6 shows that the first touch pad x6 is touched by the contact object, and the second contact signal ty5 shows that the second touch pad y5 is touched by the contact object.

Therefore, the touch sensor part 10 may detect the plurality of first contact signals tx1 to tx7 and the plurality of second contact signals ty1 to ty7 to detect the touch positions.

The foregoing describes a method of detecting a touch position when a single touch in which there is only one touch position on the touch panel occurs. However, as shown in FIG. 2 or 3, when there are a plurality of touch positions, the ghost pattern may occur.

As shown in FIG. 2, when a contact object simultaneously touches the positions A and D, the first contact signals tx3 and tx6 show that the first touch pads x3 and x6 are touched by the contact object, and the second contact signals ty2 and ty5 show that the second touch pads y2 and y5 are touched by the contact object. However, even when the contact object simultaneously touches the positions B and C, the first contact signals tx3 and tx5 show that the first touch pads x3 and x6 are touched by the contact object, and the second contact signals ty2 and ty5 show that the second touch pads y2 and y5 are touched by the contact object.

That is, when the first contact signals tx1 to tx7 show that at least two of the first touch pads x1 to x7 (for example, x3 and x6) are touched by the contact object and the second contact signals ty1 to ty7 show that at least two of the second touch pads y1 to y7 (for example, y2 and y5) are touched by the contact object, it is difficult to determine actual touch positions touched by the contact object due to existence of the ghost patterns. When the actual touch positions are A and D shown in FIG. 2, the positions B and C shown in FIG. 3 are the ghost patterns, and when the actual touch positions are B and C shown in FIG. 3, the positions A and D shown in FIG. 2 are the ghost patterns.

When the ghost patterns are generated by the multi-touch as described above, the touch sensor part 10 in accordance with the present invention determines the actual touch positions and the ghost patterns on the basis of a detection time measured with respect to the plurality of first contact signals tx1 to tx7 and the plurality of second contact signals ty1 to ty7.

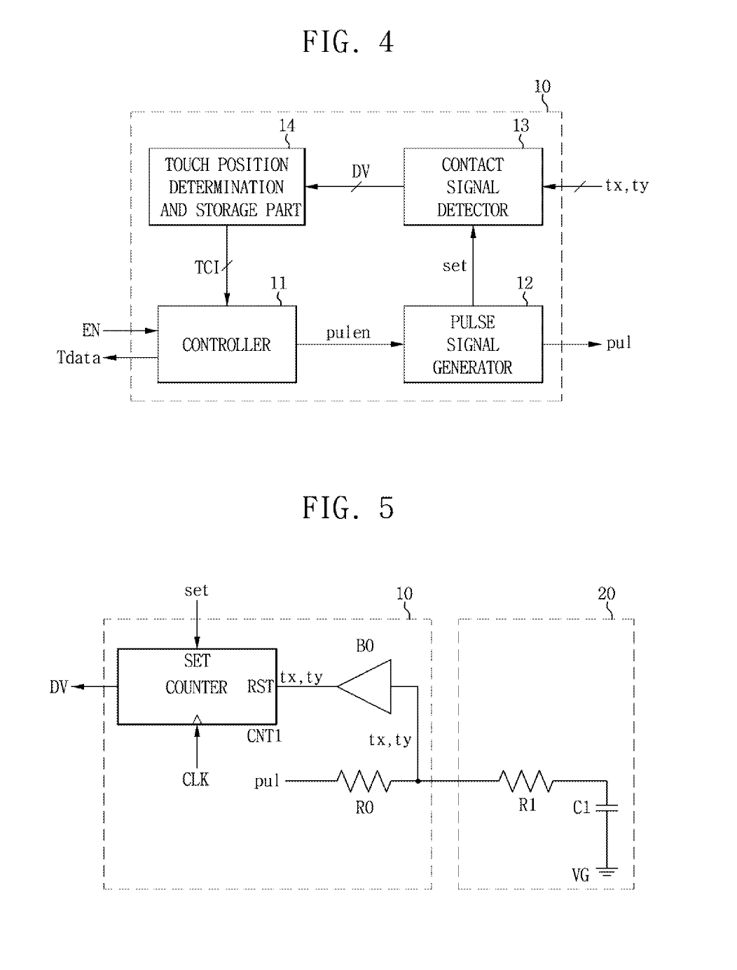

FIG. 4 is a view of an embodiment of a touch sensor part of FIG. 1.

Referring to FIG. 4, the touch sensor part 10 includes a controller 11, a pulse signal generator 12, a contact signal detector 13, and a touch position determination and storage part 14. The controller 11 outputs a pulse enable signal “pulen” to the pulse signal generator 12 in response to an enable signal EN applied from the exterior. Also, the controller 11 receives touch position information TCT from the touch position determination and storage part 14 to output touch position data “Tdata” to the exterior.

The pulse signal generator 12 activates to generate a pulse signal pu1 in response to the pulse enable signal “pulen” applied from the controller 11, and outputs the pulse signal to the plurality of touch pads x1 to x7 and y1 to y7. Here, the pulse signal generator 12 may simultaneously or sequentially apply the pulse signal pu1 to the plurality of touch pads x1 to x7 and y1 to y7 as described above. When the pulse signal generator 12 sequentially applies the pulse signal pu1 to the plurality of touch pads x1 to x7 and y1 to y7, the pulse signal generator 12 may further include a switch circuit (not shown) configured to sequentially select the plurality of touch pads x1 to x7 and y1 to y7 to electrically connect them. In addition, while the pulse signal pu1 may be generated according to a designated period, the pulse signal pu1 may be generated by receiving a separate signal representing that the contact signal detector 13 detects the contact signals tx and ty. In addition, the pulse signal generator 12 outputs a set signal to the contact signal detector 13 together with the pulse signal pu1. Here, the set signal set is a signal for representing timing when the pulse signal pu1 is output, and may be the same signal as the pulse signal.

The contact signal detector 13 includes at least one counter configured to measure the detection time of the contact signals tx1 to tx7 and ty1 to ty7 applied to the touch pads corresponding to the plurality of touch pads x1 to x7 and y1 to y7 in response to the set signal applied to the pulse signal generator 12, and output the measured detection time as a delayed value DV to the touch position determination and storage part 14. In addition, the contact signal detector 13 may include at least one buffer (not shown) configured to receive the first and second contact signals tx1 to tx7 and ty1 to ty7. Since the set signal is a signal showing timing when the pulse signal pu1 is applied to the touch pads, the counter of the contact signal detector 13 starts to count the detection time when the set signal is applied. Further, when the contact signals tx1 to tx7 and ty1 to ty7 are applied from the corresponding touch pads among the plurality of touch pads x1 to x7 and y1 to y7, the contact signal detector 13 outputs the counted value as the delayed value DV to the touch position determination and storage part 14, and simultaneously resets the counted value.

The touch position determination and storage part 14 receives and stores the delayed value DV, and compares the stored delayed value DV with the designated reference value to determine the touch pads of the plurality of first and second touch pads x1 to x7 and y1 to y7, which are touched by the contact object. In the case of the single touch, since the stored delayed value DV shows that only one touch pad of the plurality of first and second touch pads x1 to x7 and y1 to y7 is touched by the contact object, the touch position of the contact object can be instantly determined. However, when the delayed value DV of the plurality of first contact signals tx1 to tx7 and the delayed value DV of the plurality of second contact signals y1 to y7 show that at least two touch pads are touched by the contact object, it is possible to determine the multi-touch. In addition, in the case of the multi-touch, since the ghost pattern occurs as described above, it is necessary to discriminate an actual touch position. When it is determined that the contact object touches multiple positions, the touch position determination and storage part 14 analyzes the delayed values DV showing that the touch pads are touched by the contact object, and discriminates the actual touch position. Then, the touch position information TCT of the determined touch position is output to the controller 11.

In applications of zooming in, zooming out, or scrolling an image depending on the multi-touch, there is no need to discriminate the ghost pattern in the multi-touch. However, in applications of rotating an image using the multi-touch, the ghost pattern must be discriminated from the actual touch position to discriminate a rotation direction. Therefore, while not shown, the need to discriminate the ghost pattern may be transmitted to the touch position determination and storage part 14 through the controller 11 by an external application program.

In addition, while not shown, the controller 11 may receive data of a detection region in which a multi-touch is detected from the exterior. That is, the controller 11 may be set to detect the multi-touch in only a specific region of the panel part 20.

FIG. 5 is a view showing an equivalent circuit of the touch sensor part and touch pad of FIG. 1. FIG. 5 illustrates an equivalent circuit of one sensor and one touch pad among the plurality of touch pads x1 to x7 and y1 to y7.

In FIG. 5, a resistor R0 has a resistance component of the touch sensor part 10, and a resistor R1 has a resistance component from the touch pad to the touch position of the contact object. In addition, a capacitor C1 is a capacitance of the contact object, and an imaginary ground potential VG is a voltage level generated by the touch of the contact object. A buffer B0 and a counter CNT1 are installed in the contact signal detector 13. The buffer B0 receives the corresponding contact signals tx and ty to perform buffering of the signals, and outputs the buffered signals. The counter CNT1 starts counting in response to a set signal, and outputs a counted delayed value DV when the contact signals tx and ty are applied through the buffer B0.

The resistor R1 has the resistance component from a position at which a pulse signal pu1 is applied to a position at which the contact object is touched in the touch pad, and thus has a resistance value that increases as the touch position moves away from the position at which the pulse signal pu1 is applied.

FIG. 5 is a view showing the case in which the contact object is touched to the touch pad. When the contact object is not touched to the touch pad, the touch pads x1 to x7 and y1 to y7 become an open circuit so that the resistor R1, the capacitor C1 and the imaginary ground potential VG are neglected. That is, when the contact object is not touched to the touch pad, the resistor R1, the capacitor C1 and the imaginary ground potential VG are omitted from the equivalent circuit. Thus, when the touch pad is not touched by the contact object, the pulse signal pu1 is delayed by only the resistor R0, the resistance element of the touch sensor part 10, and applied to the buffer B0 as the contact signals tx and ty.

However, when the contact object is touched to the touch pad, the pulse signal pu1 is affected by the resistor R1 caused by the touch pad and the capacitor C1 caused by the contact object in addition to the resistor R0.

Provided that a voltage level in a first state of the pulse signal pu1 according to the touch is a first voltage Vdd, when the contact object is touched to the touch pad, the voltage level of the contact signal depending on a time will be represented as the following Formula 1.

$$v ( t ) / Vdd = ( 1 - {e}^{- t / τ} ) ( \frac{R 0}{R 0 + R 1} ) \\ here , \\ τ = C 1 ( R 0 + R 1 ) \qquad [ Formula 1 ]$$

In Formula 1, the time t represents a time from a moment that the pulse signal outputs. In addition, provided that the buffer B0 detects a ½ level of the first voltage Vdd to determine a first state or a second state of the contact signal, it will be represented as the following Formula 2.

$$1 / 2 = ( 1 - {e}^{- t / τ} ) ( \frac{R 0}{R 0 + R 1} ) \\ t / τ = ln ( \frac{2 R 0}{R 0 + R 1} ) \qquad [ Formula 2 ]$$

That is, a time that the voltage level of the contact signal becomes a ½ level of the first voltage Vdd is varied depending on the resistors R0 and R1 and the capacitor C1. Provided that a detection time of a contact signal of the touch pad not touched with the contact object is t0 and a detection time of a contact signal of the touch pad touched with the contact object is t1, a ratio of the detection times of the contact signals in the above cases will be represented as the following Formula 3.

$$t 1 / t 0 = \frac{ln ( 2 R 0 / ( R 0 + R 1 ) )}{ln ( 2 )} \qquad [ Formula 3 ]$$

That is, the detection time ratio is determined by the resistors R0 and R1 only. As will be appreciated from Formula 3, since the detection time t reduces as the resistance R1 increases, the detection time reduces as the touch position becomes more distant from a position at which the pulse signal of the touch pad is applied.

Therefore, in the case of the multi-touch in which there are a plurality of touch positions, the touch panel of the present invention detects coordinates of the actual touch positions on the basis of the delayed values of the contact signals tx1 to tx7 and ty1 to ty7 stored in the touch position determination and storage part 14. That is, since the touch panel can measure a detection time of the first contact signals tx1 to tx7 applied from the first touch pads x1 to x7 for detecting a touch in a first direction to detect an approximate touch position in a second direction, and can measure a detection time of the second contact signals ty1 to ty7 applied from the second touch pads y1 to y7 for detecting a touch in a second direction to detect an approximate touch position in a first direction, it is possible to determine coordinates of the actual touch positions.

TABLE 1

| | x1 | X2 | x3 | x4 | x5 | x6 | x7 |
|---|---|---|---|---|---|---|---|
| y1 | 1, 1 | 1, 1 | 0.86, 1 | 1, 1 | 1, 1 | 0.93, 1 | 1, 1 |
| y2 | 1, 0.84 | 1, 0.84 | 0.86, | 1, 0.84 | 1, 0.84 | 0.93, 0.84 | 1, 0.84 |
| | | | 0.84 | | | | |
| y3 | 1, 1 | 1, 1 | 0.86, 1 | 1, 1 | 1, 1 | 0.93, 1 | 1, 1 |
| y4 | 1, 1 | 1, 1 | 0.86, 1 | 1, 1 | 1, 1 | 0.93, 1 | 1, 1 |
| y5 | 1, 0.91 | 1, 0.91 | 0.86, | 1, 0.91 | 1, 0.91 | 0.93, 0.91 | 1, 0.91 |
| | | | 0.91 | | | | |
| y6 | 1, 1 | 1, 1 | 0.86, 1 | 1, 1 | 1, 1 | 0.93, 1 | 1, 1 |
| y7 | 1, 1 | 1, 1 | 0.86, 1 | 1, 1 | 1, 1 | 0.93, 1 | 1, 1 |

Table 1 represents each delay value of the contact signals tx1 to tx7 and ty1 to ty7 as a delay time ratio upon touch and non-touch. Therefore, the delay time ratio upon the non-touch is 1, and the delay time ratio upon the touch has a value smaller than 1. While Table 1 represents the delay time ratio for the simplicity of expression, the measured delayed value DV may be directly used. In addition, even when the non-touch occurs in actual operation, the delay time ratio may not exactly be indicated as 1 due to various noises. Therefore, when existence of the touch is determined by the delay time ratio, a predetermined margin (for example, ±0.04) may be provided with respect to 1 even upon the non-touch. In addition, it is assumed that the pulse signal is applied from an upper end of the first touch pads x1 to x7 and a left end of the second touch pads y1 to y7.

Referring to Table 1, when the delay time ratio is smaller than 1, rows and columns showing the touch of the contact object are second and fifth rows and third and sixth columns. Therefore, it can be discriminated from Table 1 that the contact object is touched to the first touch pads x3 and x6 and the second touch pads y2 and y5 from the delay time ratio stored in the touch position determination and storage part 14. In addition, the touch positions combined by the first touch pads x3 and x6 and the second touch pads y2 and y5 are expressed by four coordinates (x3, y2), (x6, y2), (x3, y5) and (x6, y5), two of which represent actual touch positions, and the others represent ghost patterns. Four positions are divided into positions A to D. The coordinates of the position A are (x3, y2), the coordinates of the position B are (x6, y2), the coordinates of the position C are (x3, y5), and the coordinates of the position D are (x6, y5).

The touch position determination and storage part 14 analyzes the delay time ratio with respect to at least one position among the positions A to D (x3, y2), (x6, y2), (x3, y5) and (x6, y5). For example, analyzing the position A (x3, y2), the delay time ratios of the position A (x3, y2) are 0.86 and 0.84. In addition, in the delay time ratios 0.86 and 0.84, the delay time ratio 0.84 of the second touch pad y2 showing the delay time ratio in a row direction is smaller than the delay time ratio 0.91 of the second touch pad y5. This means that the touch position of the second touch pad y2 is farther from the position at which the pulse signal pu1 is applied than the touch position of the second touch pad y5. Similarly, the delay time ratio 0.86 of the first touch pad x3 in the delay time ratios 0.86 and 0.84 showing the delay time ratio in the row direction is smaller than the delay time ratio 0.93 of the first touch pad x6. This means that the touch position of the first touch pad x3 is farther from the position at which the pulse signal pu1 is applied than the touch position of the first touch pad x6. This violates the assumption that the pulse signal is applied from the upper end of the first touch pads x1 to x7 and the left end of the second touch pads y1 to y7. Therefore, the position A is the ghost pattern. Similarly, the delay time ratios 0.93 and 0.91 of the position D also violate the assumption. Therefore, it will be appreciated that the positions A and D are the ghost patterns, and the positions B and C are the actual touch positions.

While the above embodiment illustrates that the delay time ratios of the first touch pads x3 and x6 and the delay time ratios of the second touch pads y1 and y5 are compared with each other, it may be possible to determine the actual touch position even when the delay time ratios of the first touch pads x3 and x6 are compared with each other. Similarly, it may be possible to determine the actual touch position even when the delay time ratios of the first touch pads y2 and y5 are compared with each other. However, in order to accurately discriminate the ghost pattern, only when the delay time ratios of the first and second touch pads x3, x6, y2 and y5 are compared and their comparison results are equal to each other, the actual touch position can be determined.

In addition, when the multi-touch occurs in the same row or column, for example, when at least two touches occur at the second touch pad y2, even though only one contact signal ty2 output from one touch pad y2 among the second touch pads y1 to y7 shows the touch, contact signals output from at least two touch pads among the first touch pads x1 to x7 show the touch. As a result, it is possible to readily detect the multi-touch without generating a ghost pattern.

The above embodiment illustrates that the pulse signal is applied to one ends of the first and second touch pads, and that the touch positions are determined using the contact signals output from the one ends from which the pulse signal is applied. However, the pulse signal may be applied to the one ends of the first and second touch pads and the touch positions may be determined using signals output from the other ends of the first and second touch pads, which is disclosed in Korean Patent Application No. 2008-0051800 and thus detailed description thereof will be omitted.

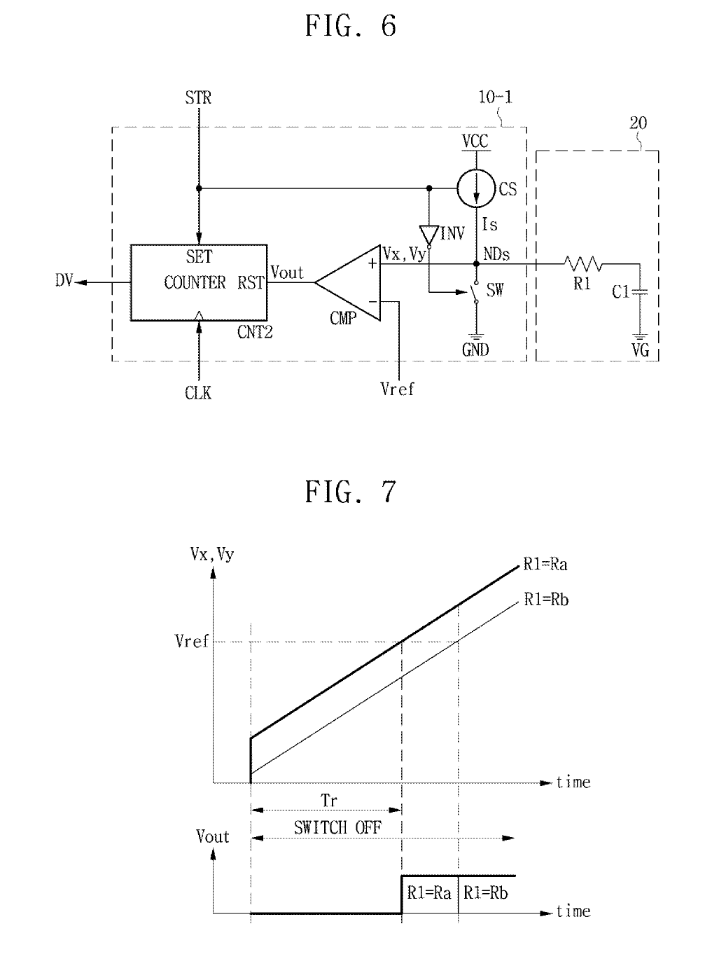

FIG. 6 is a view showing another example of an equivalent circuit of the touch sensor part and touch pad of FIG. 1. Similar to FIG. 5, FIG. 6 shows an equivalent circuit of one sensor of the touch sensor part 10-1 and one touch pad of the plurality of touch pads x1 to x7 and y1 to y7.

Since a resistor R1, a capacitor C1 and an imaginary ground potential VG of the touch pad are the same as FIG. 5, detailed description thereof will not be repeated. In addition, the touch sensor part 10-1 of FIG. 6 includes a current source CS, an inverter NV, a switch SW, a comparator CMP, and a counter CNT2. The current source CS supplies a static current Is to each of the touch pads x1 to x7 and y1 to y7 with response to a start signal STR. Here, while the start signal STR is not shown, the start signal STR may be output from the controller 11 as a signal corresponding to the pulse enable signal “pulen”. The inverter NV inverts the start signal STR to apply it to the switch SW, and the switch SW connects a detection node NDs to a ground voltage GND in response to the inverted start signal /STR.

The comparator CMP receives and compares detection voltages Vx and Vy as voltage levels of the detection node NDs and a reference voltage Vref to output an output signal Vout. The counter CNT2 receives a clock signal CLK and counts the number of clocks of the clock signal CLK, i.e., counts the detection time in response to the start signal STR. Then, when the output signal Vout applied from the comparator CMP is activated, a counted value of the number of clocks is output as a delayed value DV.

FIG. 5 illustrates that the pulse signal pu1 is applied to each of the touch pads x1 to x7 and y1 to y7, and that the pulse signal pu1 outputs the contact signal (tx, ty) delayed by the resistor R1 of the touch pad and the capacitor C1 of the contact object. However, unlike FIG. 5, in FIG. 6, the touch sensor part 10-1 includes the current source CS supplying the static current Is to each of the touch pads x1 to x7 and y1 to y7, and the current source CS supplies the static current Is to the detection node NDs in response to the start signal STR. That is, an operation corresponding to the pulse signal generator 12 of FIG. 4 is performed. When the contact object is not touched to the touch pad, the touch pads x1 to x7 and y1 to y7 become an open circuit, similar to the circuit of FIG. 5, so that the resistor R1, the capacitor C1, and the imaginary ground potential VG are neglected. That is, when the contact object is not touched to the touch pads x1 to x7 and y1 to y7, the resistor R1, the capacitor C1 and the imaginary ground potential VG are omitted from the equivalent circuit. In addition, since the switch SW is open while the start signal STR is activated, a voltage level of the detection node NDs is not varied upon the contact object. However, when the contact object is in contact with the touch pads x1 to x7 and y1 to y7 while the start signal STR is activated, the current source CS supplies the static current Is to the detection node NDs, and the voltage of the detection node NDs increases as the capacitor C1 is charged. In addition, since the resistance R1 is varied depending on the touch position of the contact object, the time that the voltage level of the detection voltage (Vx, Vy) as the voltage of the detection node NDs increases may be varied depending on the touch position of the contact object. When the start signal STR is activated, a variation in voltage level of the detection voltage (Vx, Vy) due to the resistor R1 and the capacitor C1 depending on the time will be represented as the following Formula 4.

$$Vx ( t ) = IssR 1 + \frac{Is}{C 1} t \qquad [ Formula 4 ]$$

In Formula 4, the time t represents a time from a moment that the start signal STR is activated. While Formula 4 represents the formula of the touch pads x1 to x7, the touch pad y1 to y7 will be represented as the same formula. In addition, the following Formula 5 represents the detection time until the detection voltage (Vx, Vy) has the same voltage level as the reference voltage Vref.

$$Tr = \frac{C 1 ( Vref - IssR 1 )}{Is} \qquad [ Formula 5 ]$$

The comparator CMP and the counter CNT2 constitute a circuit corresponding to the contact signal detector 13 of FIG. 4 to measure the detection time until a voltage level of the detection voltage (Vx, Vy) arrives at a voltage level of the reference voltage Vref.

The comparator CMP activates and outputs the output signal Vout when the voltage level of the detection voltage (Vx, Vy) is higher than the voltage level of the reference voltage Vref. Since the time that the voltage level of the detection voltage (Vx, Vy) increases is varied depending on the touch position of the contact object as described above, after the start signal STR is activated, the detection time is varied depending on the touch position of the contact object until the output signal Vout is activated. Then, the counter CNT2 measures the detection time until the detection voltage (Vx, Vy) arrives at the voltage level of the reference voltage Vref, and outputs the delayed value DV.

Next, when the start signal STR is inactivated, the switch SW is turned on to discharge the voltage charged in the capacitor C1, and the voltage level of the detection node NDs arrives at a level of the ground voltage GND.

FIG. 7 is a view showing variation in detection voltage and delay time depending on a touch position.

In FIG. 7, the resistor R1 has a resistance varied depending on the touch position of the contact object, like a resistor Ra or a resistor Rb. In addition, the resistance of the variable resistor R1 differentiates the detection times Tr at which the voltage level of the detection voltage (Vx, Vy) arrives at the voltage level of the reference voltage Vref, and thus, the touch position of the contact object can be detected by measuring the detection time.

Therefore, similar to FIG. 5, in FIG. 6, since the actual touch position of the contact object can be determined from the detection time of each of the touch pads x1 to x7 and y1 to y7, the multi-touch can be accurately recognized even when any ghost pattern occurs.

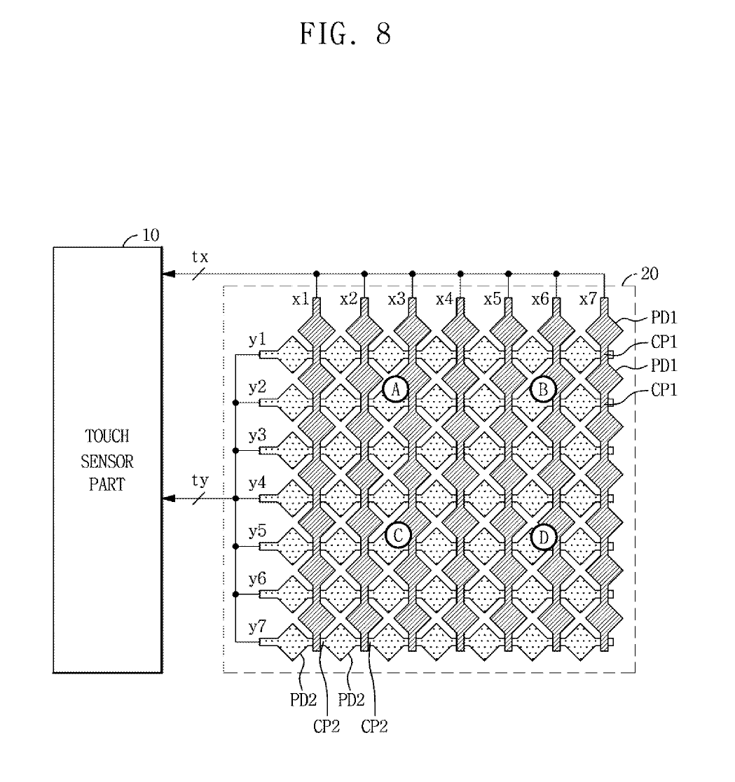

FIG. 8 is a view showing another embodiment of a touch panel in accordance with the present invention. In FIG. 8, each of the plurality of first touch pads x1 to x7 may include a plurality of first pads PD1 disposed in a second direction (for example, a y-axis direction) and first connecting pads (CP1) connecting the plurality of first pads PD1, and each of the plurality of second touch pads y1 to y7 may include a plurality of second pads PD2 disposed in a first direction (for example, an x-axis direction) and second connecting pads CP2 connecting the plurality of second pads PD2.

FIG. 1 illustrates the plurality of first and second touch pads x1 to x7 and y1 to y7 each having a bar shape. In addition, when each of the first and second touch pads x1 to x7 and y1 to y7 has the bar shape, a resistance value is evenly varied depending on the touch position. However, when the resistance value is dispersedly varied depending on the touch position of the contact object on each touch pad, it is possible to more readily determine the touch position. Therefore, in FIG. 8, each of the plurality of touch pads includes the plurality of pads PD1 and PD2 and the plurality of connecting pads CP1 and CP2 so that the plurality of touch pads x1 to x7 and y1 to y7 have dispersed resistance values depending on the touch positions.

While FIG. 8 illustrates the first pads PD1 and the second pads PD2 having a diamond shape, the first pads PD1 and the second pads PD2 may have a circular or another polygonal shape. That is, the first pads PD1 and the second pads PD2 may be evenly formed on a specific region having a certain shape.

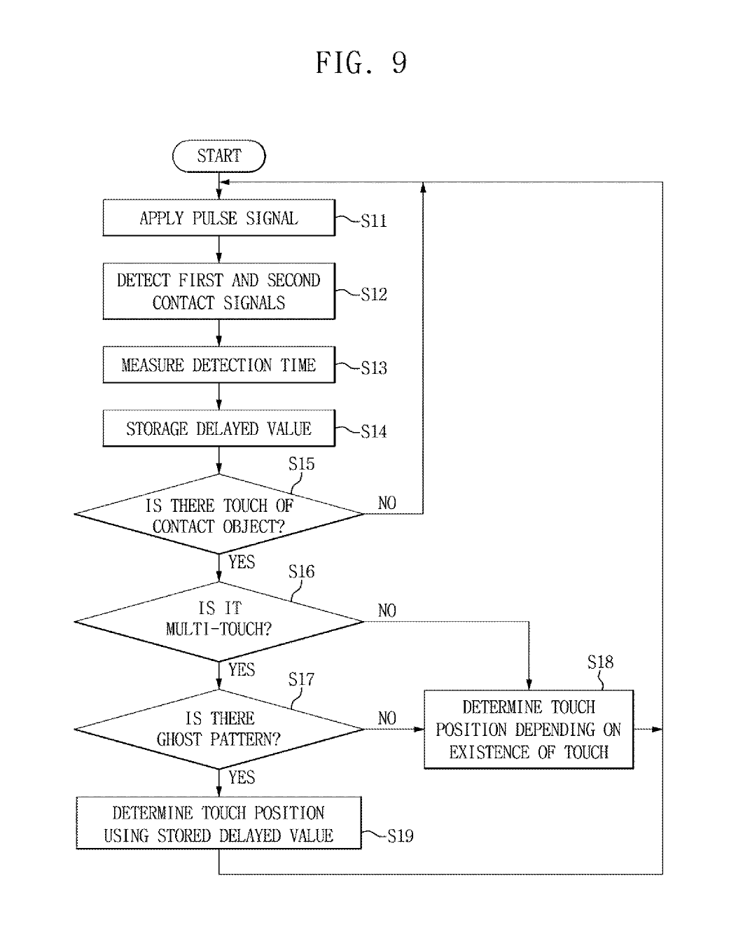

FIG. 9 is a flowchart for explaining a method of detecting a multi-touch in accordance with the present invention.

First, a controller 11 receives an enable signal EN from the exterior to activate a touch panel and output a pulse enable signal (S11). A pulse signal generator 12 applies a pulse signal pu1 to a plurality of first touch pads x1 to x7 and a plurality of second touch pads y1 to y7 in response to the pulse enable signal. In addition, the pulse signal generator 12 outputs a set signal, which is set corresponding to the pulse signal pu1, to a contact signal detector (S11).

The contact signal detector 13 detects a plurality of first contact signals tx1 to tx7 and a plurality of second contact signals ty1 to ty7 applied from the plurality of first touch pads x1 to x7 and the plurality of second touch pads y1 to y7, respectively (S12). In addition, the contact signal detector 13 measures a detection time of each of the plurality of first and second contact signals tx1 to tx7 and ty1 to ty7 with respect to the set signal set to output a plurality of delayed values DV (S13).

A touch position determination and storage part 14 receives and stores the plurality of delayed values DV (S14), and checks whether there is a delayed value showing a touch of a contact object among the plurality of stored delayed values to determine whether the contact object is touched the touch pad (S15). Here, whether the contact object is touched may be determined by the delayed value larger than a reference delayed value (not shown) among the plurality of delayed values DV stored according to a method of measuring the first and second contact signals, or the delayed value smaller than the reference delayed value (not shown). When the first and second contact signals tx1 to tx7 and ty1 to ty7 are applied from one ends of the plurality of first and second touch pads x1 to x7 and y1 to y7, to which the pulse signal pu1 is applied, the touch is represented by the delayed value smaller than the reference delayed value.

When there is at least one delayed value among the delayed values corresponding to the plurality of first contact signals tx1 to tx7 and the delayed values corresponding to the plurality of second contact signals ty1 to ty7, it means that the contact object touches the touch pad.

If no delayed value DV corresponding to the first and second contact signals tx1 to tx7 and ty1 to ty7 represents the touch, a pulse signal pu1 is applied to the plurality of first and second touch pads x1 to x7 and y1 to y7 again (S11).

When only one delayed value DV among the delayed values DV corresponding to the plurality of first contact signals tx1 to tx7 and ty1 to ty7 and the delayed values DV corresponding to the plurality of second contact signals ty1 to ty7 represents the touch, it represents a single touch (S16). Upon the single touch, the touch position of the contact object is determined by a position of the first and second touch pads corresponding to the first and second contact signals showing the touch (S18).

In addition, when at least two delayed values among the delayed values DV corresponding to the plurality of first contact signals tx1 to tx7 represent the touch, or when at least two delayed values among the delayed values DV corresponding to the plurality of second contact signals ty1 to ty7 represent the touch, it can be determined as a multi-touch (S16). However, when at least two delayed values among the delayed values DV corresponding to the plurality of first contact signals tx1 to tx7 represent the touch, while only one delayed value DV among the delayed values DV corresponding to the plurality of second contact signals ty1 to ty7 represents the touch, or when at least two delayed values among the delayed values DV corresponding to the plurality of second contact signals ty1 to ty7 represent the touch, while only one delayed value DV among the delayed values DV corresponding to the plurality of first contact signals tx1 to tx7 represent the touch, there is no ghost pattern even though the multi-touch occurs. Therefore, the touch positions of the contact object are determined by the positions of the first and second touch pads corresponding to the first and second contact signals showing a touch (S18).

However, when each of the delayed values DV corresponding to the plurality of first and second contact signals tx1 to tx7 and ty1 to ty7 represents at least two touches, it can be determined that the ghost pattern exists (S17). When it is determined that the ghost pattern is generated, an actual touch position is determined by comparing the delayed values showing the touch among the stored delayed values (S19). Here, the actual touch position may be determined by comparing delay time ratios of the first touch pads x3 and x6, or comparing delay time ratios of the second touch pads y2 and y5. In addition, in order to accurately discriminate the ghost pattern, the actual touch position can be determined only when the delay time ratios of the first and second touch pads x3, x6, y2 and y7 are compared and the compared results are equal to each other.

In addition, the touch position of the contact object is transmitted to a controller 11 as touch position information TCI, and the controller 11 receives the touch position information TCI to output touch position data to the exterior.

That is, in the touch panel of the present invention, when there is no ghost pattern, the touch of the contact object is determined by the positions of the first and second touch pads corresponding to the delayed values showing the touch. In addition, when the ghost pattern occurs, the actual touch position can be determined using the delayed values as well as the positions of the first and second touch pads.

The foregoing description concerns an exemplary embodiment of the invention, is intended to be illustrative, and should not be construed as limiting the invention. The present teachings can be readily applied to other types of devices and apparatuses. Many alternatives, modifications, and variations within the scope and spirit of the present invention will be apparent to those skilled in the art.

1. A touch panel comprising:
a panel part including a plurality of first touch pads extending in a first direction and a plurality of second touch pads extending in a second direction perpendicular to the first direction; and
a touch sensor part connected to one ends of the plurality of first and second touch pads and configured to measure and store resistance values of the plurality of first and second touch pads varied depending on a touch position of a contact object and capacitance of the contact object using a variation in detection time and to determine the touch position of the contact object,
wherein, when a plurality of touch positions are determined from the detection times corresponding to the plurality of first touch pads and the detection times corresponding to the plurality of second touch pads among the plurality of stored detection times, the touch sensor part compares relative magnitudes of the detection times showing the touch to determine an actual touch position.

2. The touch panel according to claim 1, wherein each of the plurality of first touch pads receives a pulse signal, and delays the pulse signal by the resistance value varied depending on the touch position of the contact object and the capacitance of the contact object at different times to generate a first contact signal, and
each of the plurality of second touch pads receives the pulse signal, and delays the pulse signal by the resistance value varied depending on the touch position of the contact object and the capacitance of the contact object at different times to generate a second contact signal.

3. The touch panel according to claim 2, wherein the touch sensor part comprises:
a controller configured to output a pulse enable signal to output touch position data to the exterior in response to touch position information;
a pulse signal generator configured to generate a pulse signal in response to the pulse enable signal to apply the pulse signal to the plurality of first and second touch pads, and generate a set signal corresponding to the pulse signal to output the set signal;
a contact signal detector configured to receive the set signal and the plurality of first and second contact signals to measure a delay time of each of the plurality of first and second contact signals with respect to the set signal to output the plurality of delay times as delayed values; and
a touch position determination and storage part configured to receive and store the plurality of delayed values, and determine an actual touch position of the contact object using the plurality of delayed values to output the touch position information.

4. The touch panel according to claim 3, wherein the pulse signal generator simultaneously applies the pulse signal to the plurality of first touch pads, and simultaneously applies the pulse signal to the plurality of second touch pads.

5. The touch panel according to claim 3, wherein the pulse signal generator sequentially applies the pulse signal to the plurality of first and second touch pads.

6. The touch panel according to claim 3, wherein the touch signal detector comprises:
a buffer part having at least one buffer configured to receive the first and second contact signals; and
at least one counter configured to measure the set signal and the detection time of the first and second contact signals applied to the buffer part to output delayed values corresponding to the plurality of first and second touch pads.

7. The touch panel according to claim 6, wherein the buffer part receives the plurality of first and second contact signals from one ends of the plurality of first and second touch pads from which the pulse signal is applied.

8. The touch panel according to claim 6, wherein the buffer part receives the plurality of first and second contact signals from the other ends of the plurality of first and second touch pads.

9. The touch panel according to claim 3, wherein, when each of the delayed values corresponding to the plurality of first touch pads and the delayed values corresponding to the plurality of second touch pads among the plurality of stored delayed values represents a plurality of touches, the touch position determination and storage part compares the delayed values showing the touch to determine the actual touch position and output the touch position information.

10. The touch panel according to claim 9, wherein the touch position determination and storage part compares the delayed values showing the touch corresponding to the first touch pads to determine the actual touch position.

11. The touch panel according to claim 9, wherein the touch position determination and storage part compares the delayed values showing the touch corresponding to the second touch pads to determine the actual touch position.

12. The touch panel according to claim 9, wherein the touch position determination and storage part compares the delayed values showing the touch corresponding to the first touch pads to determine a touch position, and compares the delayed values showing the touch corresponding to the second touch pads to determine a touch position, determining an actual touch position only when two touch positions are equal to each other.

13. The touch panel according to claim 9, wherein, when one delayed value corresponding to the first or second touch pad among the plurality of stored delayed values represents a touch and at least one delayed value among the delayed values corresponding to the other touch pads represents a touch, the touch position determination and storage part outputs the touch position information corresponding to the position of the first and second touch pads corresponding to the delayed values showing the touch.

14. The touch panel according to claim 1, wherein each of the plurality of first touch pads receives a static current, and generates a first contact signal to vary a voltage level by the resistance varied depending on the touch position of the contact object and the capacitance of the contact object, and
each of the plurality of second touch pads receives a static current, and generates a second contact signal to vary a voltage level by the resistance varied depending on the touch position of the contact object and the capacitance of the contact object.

15. The touch panel according to claim 14, wherein the touch sensor part comprises:
a controller configured to output a start signal to output touch position data to the exterior in response to touch position information;
a current source configured to generate a static current in response to the start signal and apply the static current to the plurality of first and second touch pads;
a touch signal detector configured to measure a detection time of each of the plurality of first and second contact signals with respect to the start signal to output a plurality of delayed values; and
a touch position determination and storage part configured to receive and store the plurality of delayed values, and determine the actual touch position of the contact object using the plurality of delayed values to output the touch position information.

16. The touch panel according to claim 15, wherein the current source simultaneously applies the static current to the plurality of first touch pads, and simultaneously applies the static current to the plurality of second touch pads.

17. The touch panel according to claim 15, wherein the current source sequentially applies the static current to the plurality of first and second touch pads.

18. The touch panel according to claim 15, wherein the touch signal detector comprises:
at least one comparator configured to receive the first and second contact signals to compare a reference voltage with a voltage level of the first and second contact signals to output an output signal; and
at least one counter configured to measure a time difference between the start signal and the output signal to output delayed values corresponding to the plurality of first and second touch pads.

19. The touch panel according to claim 18, wherein the comparator receives the plurality of first and second contact signals from one ends of the plurality of first and second touch pads from which the static current is applied.

20. The touch panel according to claim 18, wherein the comparator receives the plurality of first and second contact signals from the other ends of the plurality of first and second touch pads.

21. The touch panel according to claim 15, wherein, when the delayed values corresponding to the plurality of first touch pads and the delayed values corresponding to the plurality of second touch pads among the plurality of stored delayed values represent a plurality of touches, the touch position determination and storage part compares the delayed values showing the touch to determine the actual touch position and output the touch position information.

22. The touch panel according to claim 21, wherein the touch position determination and storage part compares the delayed values showing the touch corresponding to the first touch pads to determine an actual touch position.

23. The touch panel according to claim 21, wherein the touch position determination and storage part compares the delayed values showing the touch corresponding to the second touch pads to determine an actual touch position.

24. The touch panel according to claim 21, wherein the touch position determination and storage part compares the delayed values showing the touch corresponding to the first touch pads, and compares the delayed values showing the touch corresponding to the second touch pads, to determine the actual touch position only when two touch positions are equal to each other.

25. The touch panel according to claim 21, wherein, when one delayed value among the delayed values corresponding to the first or second touch pad among the plurality of stored delayed values represents the touch and when at least one delayed value among the delayed values corresponding to the other touch pads represents the touch, the touch position determination and storage part outputs the touch position information corresponding to the first and second touch pads corresponding to the delayed values showing the touch.

26. A multi-touch detecting method for a touch panel including a plurality of first touch pads extending in a first direction and a plurality of second touch pads extending in a second direction, the method comprising:
a pulse signal outputting step of generating a pulse signal in response to a pulse enable signal to output the pulse signal to each of the plurality of first touch pads and the plurality of second touch pads;
a delayed value storage step of measuring a delay time of each of the plurality of first and second contact signals output from the plurality of first and second touch pads with respect to the pulse signal to store a plurality of delayed values;
a touch determination step of determining existence of the touch of the contact object using the plurality of stored delayed values and whether a multi-touch occurs or not;
a ghost pattern determination step of determining whether a ghost pattern occurs when the multi-touch occurs; and
a touch position outputting step of comparing relative magnitudes of the delayed values showing a touch among the plurality of stored delayed values depending on a touch position to output an actual touch position when recognition of the ghost pattern is needed.

27. The method according to claim 26, wherein the pulse signal outputting step includes sequentially outputting the pulse signal to the plurality of first and second touch pads.

28. The method according to claim 26, wherein the touch determination step comprises:
a delayed value determination step of comparing each of the plurality of stored delayed values with a reference delayed value to determine whether at least one delayed value represents a touch;
a single touch determination step of determining whether one delayed value from delayed values corresponding to each of the plurality of first and second touches among the a plurality of stored delayed values represents a touch; and
a multi-touch determination step of determining whether a plurality of delayed values among the delayed values corresponding to the plurality of first touch pads or the delayed values corresponding to the plurality of second touch pads represent a touch.

29. The method according to claim 28, wherein the ghost pattern determination step includes determining that the ghost pattern occurs when the plurality of delayed values represent a touch at each delayed value corresponding to each of the plurality of first and second touch pads.

30. The method according to claim 29, wherein the touch position outputting step includes comparing the plurality of delayed values showing the touch to determine the actual touch position of the contact object.

31. The method according to claim 30, wherein the touch position outputting step includes comparing the delayed values showing the touch corresponding to the first touch pads to determine the actual touch position.

32. The method according to claim 30, wherein the touch position outputting step includes comparing the delayed values showing the touch corresponding to the second touch pads to determine the actual touch position.

33. The method according to claim 30, wherein the touch position outputting step includes comparing the delayed values showing the touch corresponding to the first touch pads, and comparing the delayed values showing the touch corresponding to the second touch pads, to determine an actual touch position only when two touch positions are equal to each other.
